(19) United States
(12) Patent Application Publication
(10) Pub. No.: US 2009/0073066 A1
(43) Pub. Date: Mar. 19, 2009

(54) Grid Antenna

(75) Inventors: David Frederick Jordon, Danville, NH (US); Thomas Sherman Laubner, Merrimac, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/855,394

(22) Filed: Sep. 14, 2007

(51) Int. Cl. H01Q 13/10

(52) U.S. Cl. 343/770

(57) ABSTRACT

An antenna comprising a layer of conductor having a plurality of non-conductive slits disposed therein, each slit comprising a longitudinal dimension greater than a transverse direction, a feed line disposed beneath the layer of conductor to couple signal energy between the feed line and the slits, wherein the feed line crosses each slit in the transverse direction at least once, and a dielectric layer separating the layer of conductor from the feed line.

### FIELD OF THE INVENTION

The invention pertains to antennas.

### BACKGROUND OF THE INVENTION

Slot antennas are well-known in the art of wireless communications in radiating (transmitting) applications, receiving applications, or both simultaneously. Any discussion of radiating or receiving in connection with antennas in this specification is merely exemplary. Throughout, this specification will discuss exemplary antennas in the context of radiating, i.e., transmitting. However it should be understood that the inventive antennas disclosed herein also could be used as receiving antennas and that, unless otherwise specified or obvious, the features, advantages, properties, etc. discussed herein in connection with a transmitting antenna are applicable (with proper modification for the inverse natures of receiving versus transmitting) to use of the antenna as a receiving antenna.

Antennas of all types, including slot antennas, are commonly designed and used for their far field properties. Far field is primarily an electric field. While there is no single accepted definition of far field, it generally refers to the field radiated by an antenna measured at a distance of R=(nD²)/λ where n is an integer generally accepted as 2 or more, D is the maximum linear dimension of the antenna, and λ is the operating wavelength. Almost all of the literature on antennas pertains to their far field properties.

However, antennas also have near field radiation that is primarily or exclusively a magnetic field and which is different from its far field properties. Near field properties of antennas is largely ignored in the literature and in the design of antennas. Far field power attenuates at a rate of 1/r², whereas near field power attenuates at a rate of 1/r³, where r is distance. Therefore, near field radiation typically is relevant only very close to the antenna. The near field radiated by an antenna essentially is primarily comprised of the magnetic flux generated around the antenna by the current running through the antenna.

Again, while there is no definitive, well-accepted definition of near field, it generally refers to the field within about ¼ to 1 wavelength of the antenna center frequency.

Interest in the antenna industry lies almost exclusively in the far field properties of antennas because antennas are rarely used for transmitting over distances of less than one wavelength. For instance, the wavelength at 900 MHz, which is in the UHF (Ultra High Frequency) band, is approximately 13 inches.

Recently, the use of radio frequency identification (RFID) tags has increased dramatically. RFIDs are used, for example, in warehouses to track the location of goods. RFIDs basically are small circuits placed on or embedded into a product or, more commonly, in the box or palette in which the product is shipped. A passive RFID tag basically comprising an antenna, a diode, and a digital circuit that can output a particular designated ID signal to the antenna for radiating out to an RFID interrogation unit. The number, for example, indicates that this is a box of 25 model G35 cellular telephones manufactured by XYZ Telephone Manufacturing Company. Commonly, that ID signal is simply a number represented in PCM (pulse code modulation), FM (frequency modulation), or any other technique used for wireless transmissions.

An RFID tag is interrogated by an interrogation unit that includes a transmitting antenna, a receiving antenna (which may be the same antenna as the transmitting antenna or a different antenna), circuitry for generating a signal to transmit to the RFID tags within range of the interrogation unit to wake them up to transmit their ID, and circuitry for reading the ID. More particularly, an antenna on the interrogation unit radiates energy within the bandwidth of the antenna of the RFID tag that is received by the antenna of the RFID tag and causes current to flow on the RFID antenna. The diode is coupled to the antenna of the RFID tag so that the current on the antenna flows to the diode. If the signal received from the interrogation unit is strong enough, it turns on the diode, which charges a capacitor. When the capacitor reaches a sufficient charge, it turns on the circuit causing it to output the ID signal to the RFID tag's antenna. The RFID tag antenna radiates the ID signal. The receiving antenna of the interrogation unit receives the ID signal, which signal is then sent to the reader circuit, which determines the ID. While RFID interrogation units usually are used within a very close range for the RFID, they nevertheless still usually operate using the far field, rather than the near field.

### SUMMARY OF THE INVENTION

An antenna comprising a layer of conductor having a plurality of non-conductive slits disposed therein, each slit comprising a longitudinal dimension greater than a transverse direction, a feed line disposed beneath the layer of conductor to couple signal energy between the feed line and the slits, wherein the feed line crosses each slit in the transverse direction at least once, and a dielectric layer separating the layer of conductor from the feed line.

### BRIEF DESCRIPTION OF THE DRAWINGS

FIG. 1 is a plan view of the top surface of a grid antenna in accordance with a first embodiment of the present invention.

FIG. 2 is a plan view of the bottom surface of the grid antenna of FIG. 1.

FIG. 3 is a transparent plan view of the antenna of FIGS. 1 and 2 as seen from the top illustrating how the grid and microstrip overlie each other.

FIG. 4 is a perspective view of a grid antenna in accordance with a second embodiment of the present invention including a reflector forming part of the ground plane.

FIG. 5 is a plan view of the top surface of a grid antenna in accordance with a second embodiment of the present invention.

FIG. 6 is a plan view of the bottom surface of the grid antenna of FIG. 5.

FIG. 7 is a transparent plan view of the antenna of FIGS. 5 and 6 as seen from the top illustrating how the grid and microstrip overlie each other.

### DETAILED DESCRIPTION OF THE INVENTION

Antennas that use the near field for communication as opposed to the far field can be used for very close range wireless communication. Merely as one example, as RFID tags shrink in size, it is becoming practical to use very small RFID tags on individual products (rather than on the palettes or boxes containing the products). In such cases, it would be practical, and often desirable, to place the antenna of the interrogation unit very close to the RFID tag being inspected.

For example, some applications for near field antennas might involve an automated situation wherein the location of the RFID tag is not known exactly, but merely known to be within a relatively limited volume of space. Therefore, it would be desirable to develop an interrogation unit antenna that can flood a certain defined volume of space with near field energy for activating and/or reading RFID tags.

Of course, there are other applications for near field antennas that do not involve the use of RFID tags and no implication should be taken that the antennas of the present invention are suitable only for use with RFID tag reading systems.

For instance, in a manufacturing plant, it may be desirable to read the RFID tags of items on a table or conveyor belt or otherwise passing through a relatively well defined volume of space. Also, it may be desirable to embed RFID tags in sheets of paper and to program those tags as those sheets of paper are being printed inside of a printer.

In any of these applications, the volume of space within which the tag may be present is almost planar, i.e., the volume may be relatively large in the x and y dimensions, but is relatively small in the third, or z, dimension. For example, in the printer example mentioned above, an RFID tag embedded in a sheet of paper passing through the printer during printing will be known to pass through a predetermined volume that is as wide and as long as the sheet of paper (e.g., 8.5 inches by 11 inches), but very thin (e.g., the width of a common sheet of paper).

Thus, such applications present a use for wireless communication antennas that can flood a volume of space with near field magnetic radiation, especially a space that is relatively large in two dimensions, but relatively shallow in the third dimension.

All antennas, including antennas intended to operate only in the near field, radiate both near field and far field energy. Therefore, care may need to be taken in connection with the design of the antenna and transmitter to assure that the far field properties of the antenna are carefully controlled. For instance, governments often promulgate regulations for wirelessly transmitted signals. For instance, the Federal Communications Commission (FCC) of the United States requires that radiating antennas used for RFID type systems have no more than 36 dBM of EIRP (Effective Isotopic Radiated Power). Since most transmitters transmit at about 30-31 dBM, antennas used with such transmitters can have a far field gain of no more than 5 or 6 dBM. Any specific application may actually require much less far field power due to practical considerations other than the applicable government regulation. For instance, an antenna in a printer probably would need to be located quite close to other equipment in the printer. A strong far field signal from the antenna may interfere with the operation of that other equipment.

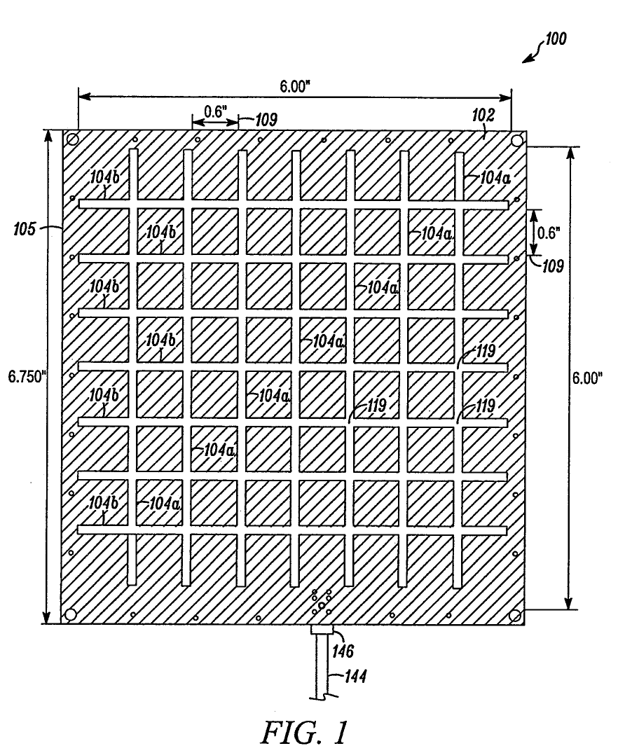

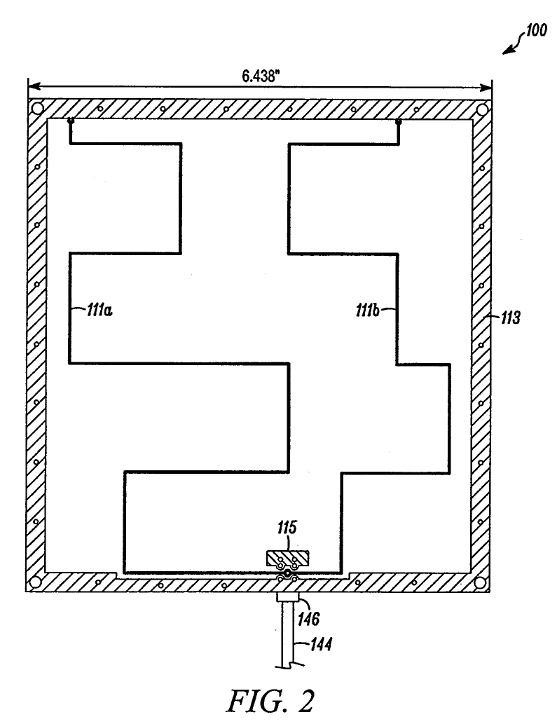

FIGS. 1 and 2 are plan views of the front and back, respectively, of an antenna 100 in accordance with a first embodiment of the present invention. This antenna can flood a volume of space, and particularly a shallow volume of space near the antenna, with near field magnetic radiation, while producing minimal far field radiation.

The antenna 100 is a new type of antenna, herein termed a grid antenna. It essentially operates on the same principles as a slot antenna, but, as indicated above, is particularly adapted for near field radiation and is particularly capable of flooding a zone above the antenna with near field radiation over a wide area parallel to the antenna, while producing minimal far field radiation.

The antenna 100 comprises a layer of conductor 102 including a plurality of slits 104, which slits comprise an area in the conductor layer in which conductor is absent (i.e., a gap). Each slit has a longitudinal dimension greater than its transverse dimension. For purposes of this specification, the term slit refers to the full longitudinal extent of each such shaped structure. Thus, by way of example, in the embodiment shown in FIG. 1, the antenna comprises a first subset of seven slits 104a oriented in one direction (left to right in the Figure) and a second subset of seven more slits 104b oriented orthogonal thereto (up and down in the Figure). Furthermore, each slit 104a in the first subset of slits is intersected by each slit in the second subset of slits.

The near field radiation comprises magnetic field lines that are perpendicular to the plane of the slits from which they are radiating (in and out of the page). By contrast, the far field radiation comprises electrical field lines that are in the plane of the slits and orthogonal to the long dimension of the slit from which it is radiating.

In the embodiment illustrated in FIGS. 1 and 2, the antenna is formed on a PCB substrate 105, such as FR-4 or Getek DS. However, these are merely exemplary. For example, the substrate can be ceramic.

In an even further embodiment of the invention, the substrate can be a sheet of metal with the slits stamped into it. In that type of embodiment, however, the feed structure would need to be very complex, as will become clear from the discussion to follow.

The top surface of the substrate 105 is covered with a conductive layer 102, which may be copper or another conductive metal. The conductive layer 102 is the ground plane of the antenna 100. In one embodiment, the metal is deposited on the PCB substrate by vacuum deposition or as printed conductive inks and the slits are etched into it using conventional photolithography techniques for metals. However, all of this is merely exemplary and the antenna can be fabricated using entirely different materials and techniques.

For impedance purposes the length of the slits normally is set to about ¼ or ½ of the wavelength of the desired center frequency of the antenna.

The slits 104a in the first subset of slits and the slits 104b in the second subset of slits cross each other at intersection points 119. The length of the portion of each slit between adjacent intersections, as illustrated in the drawings by reference numerals 109, need not be any particular length. However, it may be desirable to set the length as a function of at least the size of the antenna of the RFID tags that the antenna is to be used to detect. Particularly, it may be advisable to set the spacing of the slit segments so that there are no gaps in the near field leakage out of the antenna in the direction parallel to the surface of the antenna in which the smallest RFID tag to be detected by the antenna may hide (i.e., not be detected by the antenna). The optimum spacing will depend on many factors and may best be determined on a trial and error basis. We have found in at least one instance that segments 109 of about 0.6 inches provided excellent detection of RFID tags having generally circular antennas of about 0.354 inch diameter.

In one embodiment of the invention, all of the slits 104a, 104b are of equal length. However, in other embodiments, it is possible to provide slits of slightly differing lengths to provide greater bandwidth for the antenna or even provide a dual bandwidth antenna.

Also, the Figures illustrate a grid antenna with straight slits 104a, 104b arranged in two groups orthogonal to each other because this is an easy layout to manufacture. However, the slits need not be straight and the grid pattern need not be rectilinear.

On the back side of the antenna as illustrated in FIG. 2, a feed structure such as one or more microstrips 111a, 111b feed the antenna with a signal. The back side of the substrate 105 is non-conductive except around the edges, where a metal strip 113 runs completely around the outside of the substrate 105. This metal edge 113 is in electrical contact with the metal on the front side of the antenna and, therefore, forms part of the ground plane of the antenna. The microstrip(s) 111a, 111b do not contact the metal edge 113. In a transmitting application, the slits are fed with a signal from a transmitter 113 via a coupler 115.

The metal edge provides consistent grounding throughout the antenna design and assists in bleeding off static charge.

In the illustrated example, there are two microstrips 111a, 111b and they are terminated with resistors at their far ends, i.e., the open-circuited ends away from the point 115 where the signal enters (or leaves, in the case of a receiving antenna) the substrate. The resistors are optional and may be provided primarily to impedance match the microstrips to the receiver, transmitter, or transceiver to which they are coupled. The microstrips 111a, 111b are arranged on the back side of the substrate 105 so that they cross the slits 104a, 104b orthogonally thereto at multiple locations spread out relatively evenly over the entire area covered by the slits. Each time a microstrip crosses a slit, it excites that slit. Particularly, it generates a voltage transversely across the slit which causes current to leak out of the slit. Thus, every time a microstrip crosses a slit, it loses energy to the slit. Hence, the slit radiates, as would any slot-type antenna having a voltage induced transversely across it.

By suitably meandering the microstrip(s) on the back side of the substrate to cross the slits many times over a wide area, the volume around the antenna can be flooded relatively uniformly with near field radiation from the antenna.

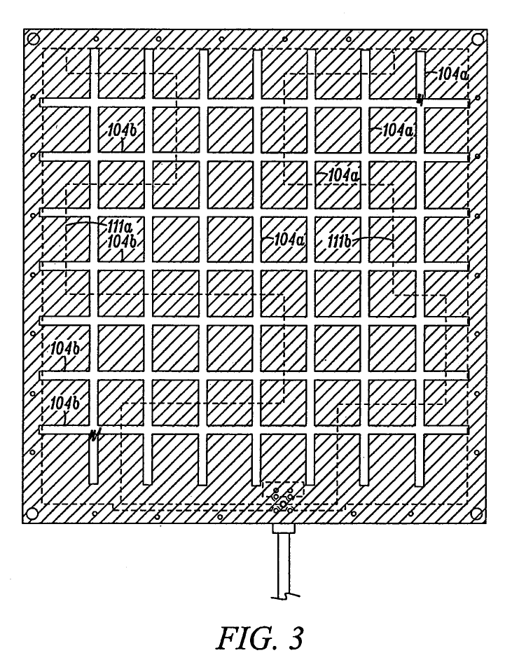

In theory, the most uniform near field radiation pattern might be achieved by meandering the microstrip(s) so that each segment 109 is crossed by a microstrip. The antenna certainly can be designed accordingly. However, this is not necessary. In fact, referring to FIG. 3, which is a transparent top view of the antenna of FIGS. 1 and 2 showing the microstrips 111a and 111b and the slits 104a, 104b overlapping, it can be seen that the microstrips do not cross every segment 109 of the antenna 100 in this first embodiment. This is because reasonably uniform coverage can be achieved with much fewer crossings. In fact, as will be discussed in connection with the second embodiment discussed herein, in some embodiments, it is advantageous to cross each slit only once with the microstrip or other feed mechanism.

With reference to the embodiment as illustrated in FIG. 3, preferably, to help assure uniformity of near field radiation (or reception, in the case of a receiving antenna), the crossings are spread out relatively uniformly and not concentrated in one area while absent in another area.

Furthermore, there are other, countervailing issues at play in designing the meandering pattern of the microstrips. Particularly, depending on the particular application, it often may be a design goal to minimize far field radiation for any or all of the reasons set forth previously in this specification. Minimizing far field radiation can be accomplished by patterning the locations where the microstrip(s) cross the slits relative to each other so that the different slits are excited with signals from the microstrip(s) that are out of phase with each other. Therefore, the far field radiation that will inherently also radiate out of the various slits will interfere destructively so as to minimize far field radiation. Furthermore, this type of semi-randomized patterning of the crossings of the microstrip with the slits helps randomize the polarization of any far field radiation so that any far field signal is unpolarized.

For instance, as can be seen in FIG. 3, the two microstrips 111a, 111b cross the slits at variable distances from the signal source point 115 thereby randomizing the phase of the signal that excites each different slit. Also, sometimes the two microstrips cross a particular transverse slit 104b in the same direction and sometimes in opposite directions. Even further, they cross the vertical slits 104a at variable distances from each other. The potential designs for microstrip meanderings are almost limitless. However, there are some conditions that it is probably better to avoid. For instance, two microstrips (or even two portions of the same microstrip) should not run parallel and close to each other for any significant length to avoid coupling there between. This should especially be avoided with the two microstrips (or microstrip portions) running in opposite directions to each other since their opposing phases would likely cause the signal to be cancelled out. Hence, the far field energy radiated from the antenna is randomly phased as well as randomly polarized.

The most appropriate number of microstrips and their lengths for any given antenna design will be a function of several practical considerations, including, but not limited to, the aforementioned impedance matching issue. Furthermore, as described above, energy basically leaks out of each microstrip 111a, 111b where it crosses underneath the slits 104a, 104b. Thus, after each slit-crossing, there is less energy in the microstrip on the far side of that crossing. Eventually the energy remaining in the microstrip will be too weak to radiate sufficiently strongly through the next slit to be crossed to provide acceptably strong field above the antenna. Thus, for instance, instead of using one long microstrip, two microstrips of half that length provide a more uniform near field radiation pattern above the antenna. Increasing the number of microstrips and reducing their lengths, of course, is a trade off. Specifically, using two microstrips cuts the initial power in each microstrip in half, but also cuts in half the rate of decrease in energy in each microstrip over its length. Furthermore, while, in theory, the most uniform near field radiation pattern is achieved by crossing each segment 109, this is likely to be impractical because it would cause the microstrip(s) to be too long. Again, there are many variables to counterbalance in achieving the most acceptable compromises of uniformity of near field radiation, power of near field radiation, and minimization of far field radiation.

Typically, the appropriate number of microstrips will be about two to three and the appropriate length would be about 1 to 1.25 wavelengths of the center frequency of the antenna. However, these numbers and dimensions are merely exemplary.

In one exemplary embodiment of the invention designed to read tags in a frequency band of 902-928 MHz with a center frequency of approximately 915 MHz, the substrate 105 is 6.750″×6.438″. Each slit is 6.000 inches long (about ½ wavelength in dielectric) and the edges of the slits between intersections 119 are 0.600 inches. The two microstrips are each about 7.5 inches long.

The exemplary antenna of FIGS. 1-3 produces a near field radiation pattern that is a relatively uniform in a zone from the surface of the antenna to about two inches above and below the antenna and having a lateral extent of about one inch beyond the lateral ends of the slits. Therefore, the “zone” is about 8″×8″×4″ (the last dimension comprising the two inches above the antenna and the two inches below the antenna).

The antenna can be coupled to a receiver, transmitter, or transceiver by any reasonable means. FIGS. 1-3 illustrate a coaxial cable 144 connected to an edge connector 146 on the substrate. The center conductor of the coaxial cable may be coupled to the ground plane and the outer conductor coupled to the microstrips 111.

A plurality of antennas in accordance with the principles of the present invention can be arrayed, either on the same substrate or on separate substrates to create an even larger zone of the coverage. For instance, a 2×2 planar array of these approximately 7 inch×7 inch square antennas can cover an area of almost 20 inches×20 inches with near field radiation immediately above the antenna, e.g., within a range of about 1 to 2 inches from the slits.

When arrayed in a grid, each antenna could experience mutual impedance with the surrounding antennas. Accordingly, in order to simplify the process of setting the impedance of the antenna for purposes an impedance matching, it may be beneficial to ensure that each antenna is far enough away from its neighboring antennas to minimize or eliminate mutual impedance effects. In the exemplary antenna, the required distance might be about two inches.

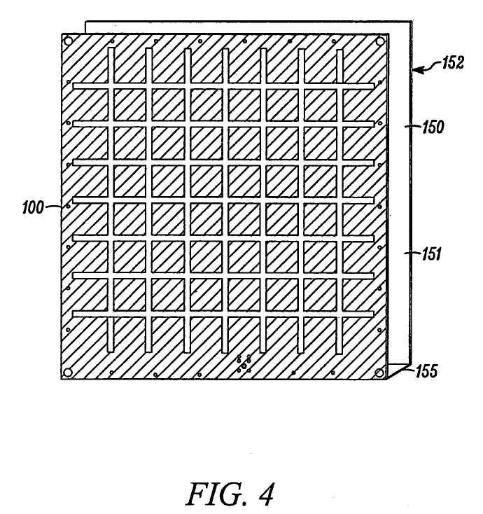

Since antennas often are mounted on or near large conductive items, such as a pole or a piece of equipment with conductive circuitry, housings, etc., it may be desirable to include a reflector 150. FIG. 4 illustrates such an embodiment. The reflector 150 may comprise a sheet of conductor positioned generally parallel to the plane of the slits (although the slits and the conductive layer within which they are disposed need not necessarily be planar). The reflector 150 serves one or more of several purposes. First, the reflector may shield the antenna from radiation from other equipment located behind the reflector that might otherwise affect the operation of the antenna 100. Second, the reflector may shield other equipment located behind the reflector from radiation from the antenna. Third, a relatively large conductive surface, such as the reflector, electrically coupled to and, therefore, part of the ground plane of the antenna would help set the ground plane conditions of the antenna, and particularly the impedance of the antenna. Particularly, the reflector and ground plane help define the impedance of the antenna. It is important to accurately control the impedance of the antenna so as to match it with the impedance of the circuitry with which it will be used. Most antennas typically should have an impedance of about 50 to 70 ohms so that they are impedance matched to conventional transmitters, receivers, and transceivers, which commonly have an impedance of 50 to 70 ohms.

Specifically, if the antenna is designed with the reflector in mind, which is a large conductor in the vicinity of the slits, then mounting the antenna next to another large conductor, such as a pole, metal housing, or other equipment, would have very little effect on its ground plane conditions, since the antenna has already been designed to operate with a large conductor next to it.

The reflector 24 can be anything that reflects RF radiation. In one embodiment, the reflector is a brass plate. The plate may be formed in the shape of an L and attached to the ground plane at the end of the bottom segment of the L.

In one embodiment, the reflector 150 is a sheet of dielectric with a metal coating 151 on one side. The metal side 151 would face the antenna 100 and the dielectric side 152 would face away from the antenna. Such a reflector would be particularly suitable for an application in which the antenna is positioned near high-voltage equipment. The dielectric side would face towards the equipment and prevent fields radiating from the equipment from reaching the antenna. The metal side would protect the high-voltage equipment from the radiation from the antenna, which would be reflected away from the voltage equipment by the reflector

The cavity depth between the reflector and the slit can be relatively small. In the exemplary antenna operating with a center frequency of 912 MHz, it is about 0.75 inches. This gap 154 can be made smaller by filling the gap with a high dielectric constant material. However, in less demanding applications, the gap may be an air gap or may be filled with low dielectric foam.

Advantageously, the far field gain of the antenna is very low, approximately −1 dBi. Nevertheless, there is sufficient energy to read far field tags within about an inch or two of the antenna. Accordingly, the antenna can be used in situations where it is desired to read both near field and far field tags within a few inches of the antenna.

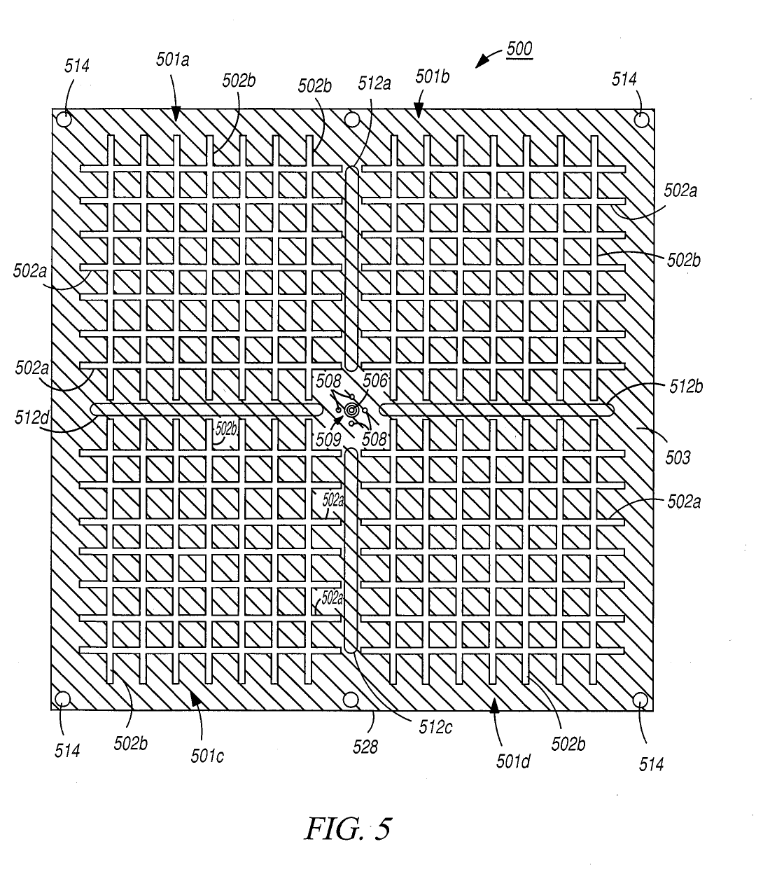

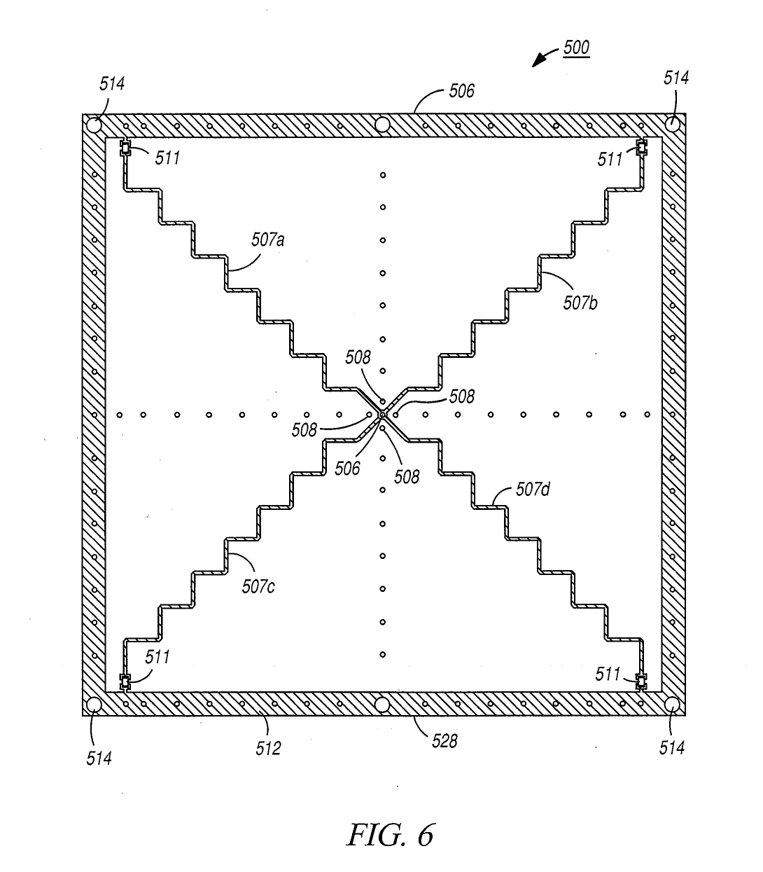

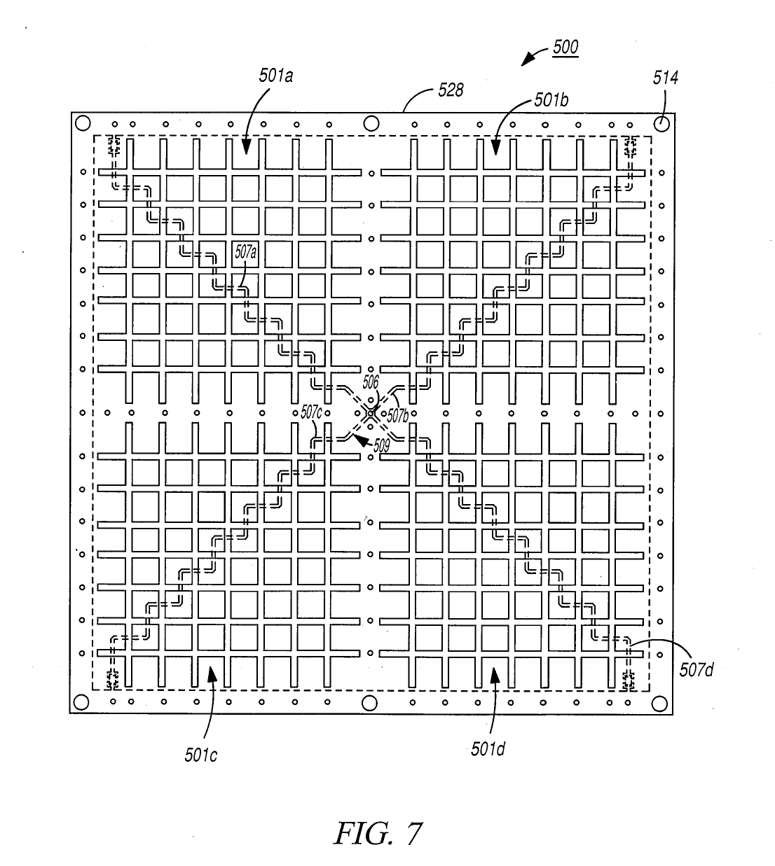

FIGS. 5-7 are top, bottom and transparent views, respectively, illustrating an antenna 500 in accordance with a second embodiment of the present invention. This embodiment comprises four grid segments 501a, 501b, 501c, 501d embodied in a ground plane 503 of a suitable substrate 528. The antenna shown in FIGS. 5-7 should not be considered to be an array of distinct grid antennas such as previously discussed in this specification, but to be a single grid antenna. Each grid segment comprises a two pluralities of orthogonal, intersecting slits 502a, 502b, similarly to the embodiment of FIGS. 1-3. The grid is symmetric about a coupler 509 in the center of the substrate 505. The signal appears on contact/via 506, and contacts/vias 508 are coupled to signal ground.

Four microstrips 507a, 507b, 507c, 507d radiate outward symmetrically from the contact 506 toward one of the grid segments 501a, 501b, 501c, 501d. Each microstrip 507a, 507b, 507c, 507d zig-zags so that it crosses each one of the slits 502a in the first plurality of slits and each one of the slits 502b in the second plurality of slits orthogonally thereto once. The center feed design symmetry of this design helps provide a very uniform near field magnetic radiation pattern.

In this embodiment, it has been found that crossing each slit once is sufficient to cause the slit to radiate over its entire length. Each microstrip is kept relatively short. The microstrips may be terminated with resistors 511 to impedance match them to the transmitter/receiver/transceiver to which they are coupled. Note that the four microstrips are in parallel, so that, for instance, to achieve a resistance of 50 ohms as seen by the transceiver, each resistor would be 200 ohms (assuming for simplicity that the impedance of each microstrip is negligible).

Each slit can be about ½ wavelength of the desired center frequency of the antenna. It has been found, for instance, that about ⅝ wavelength provides excellent performance.

Providing the grid in four separated segments permits ground from contacts/vias 508 to reach the peripheral edges of the substrate 528. Specifically, if not for the discontinuities in the slits that exist between the four grid segments (see the areas designated 512a, 512b, 512c, 512d), then most of the conductor in the top surface of the substrate would not be in electrical contact with the ground signal contact points 508 and thus would not be a ground, but would be floating. Note that, even with the segmentation into four grid segments, the squares of conductor in the insides of the grid segments are not electrically in contact with ground. This also was true in the first embodiment of FIGS. 1-3.

In a preferred implementation of this embodiment, a metal edge 512 tied to the ground plane 503, such a through plated vias 514, surrounds the periphery of the bottom surface of the substrate in which the microstrips are disposed in order to tie ground to both sides of the board.

A reflector like the one illustrated in FIG. 4 may be incorporated into this design also. The reflector need not be tied to ground however. It will still serve its primary function of preventing interference between the antenna and electrical fields or equipment on the opposing side of the reflector.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. An antenna comprising:
a layer of conductor having a plurality of non-conductive slits disposed therein, each slit comprising a longitudinal dimension greater than a transverse dimension;
a feed structure disposed beneath the layer of conductor to couple signal energy between the feed structure and the slits, wherein the feed structure crosses each slit in the transverse direction at least once; and
a dielectric layer separating the layer of conductor from the feed structure.

2. The antenna of claim 1 wherein the slits are arranged in a uniform pattern.

3. The antenna of claim 1 wherein the slits are arranged in a grid wherein a first subset of the slits are parallel to each other and a second subset of the slits are substantially orthogonal to the first subset of the slits.

4. The antenna of claim 3 wherein the first subset of slits cross the second subset of slits at intersection points to form the grid.

5. The antenna of claim 4 wherein each slit comprises a plurality of segments, the segments having a length in the longitudinal direction of the slit defined by the distance between adjacent intersection points of each slit by another orthogonal slit.

6. The antenna of claim 5 wherein the length of each slit is about ⅝ of a wavelength of a center frequency of the antenna.

7. The antenna of claim 1 wherein the feed structure is arranged relative to the slits to provide destructive phase interference between the far field electromagnetic radiation emanating from the slits.

8. The antenna of claim 1 wherein the feed structure meanders beneath the slits so as to produce a uniform near field in a volume around the conductor layer.

9. The antenna of claim 8 wherein the volume is a volume within 1 wavelength of the near field radiation from the slits.

10. The antenna of claim 1 wherein the feed structure comprises multiple microstrips originating from the same node.

11. The antenna of claim 1 wherein the feed structure comprises a plurality of microstrips.

12. The antenna of claim 1 wherein the feed structure comprises multiple microstrips originating from the same node and having opposite ends and further comprising resistors disposed at the opposite ends of the microstrips.

13. The antenna of claim 1 wherein the layer of conductor is disposed on a first side of a substantially planar substrate and the feed structure is disposed on a second, opposing side of the substrate.

14. The antenna of claim 13 wherein the feed structure is surrounded by a conductive material disposed on the second side of the substrate.

15. The antenna of claim 1 wherein the feed structure is disposed substantially in a plane and wherein the plane is surrounded by conductive material in electrical contact with the layer of conductor and not in electrical contact with the feed structure.

16. The antenna of claim 1 further comprising a reflector disposed beneath the feed structure.

17. The antenna of claim 3 further comprising a substrate on which the conductive layer is disposed, and a feed point in the center of the layer of conductor coupled to a signal source/destination, and wherein the grid is comprised of multiple grid segments, each comprising a first subset of slits parallel to each other and a second subset of slits substantially orthogonal to the first subset of the slits, the grid segments arranged symmetrically about the feed point, the grid segments separated from each other by continuous portions of conductor in the layer of conductor.

18. The antenna of claim 17 wherein the feed structure comprises a plurality of microstrips radiating symmetrically from the feed point.

19. The antenna of claim 18 wherein each microstrip feeds one grid segment and each microstrip transversely crosses each slit in the associated grid segment once.

20. The antenna of claim 19 wherein the microstrips are disposed on a side of the substrate opposing the conductor layer and wherein each microstrip extends in a zig zag pattern toward a peripheral edge of the substrate.

21. The antenna of claim 17 wherein each slit is about ⅝ wavelength of a center frequency of the antenna.

22. A radio frequency identification tag reader comprising:
circuitry for reading data stored in a radio frequency identification tag; and
an antenna for at least one of transmitting near field radiation to excite a radio frequency identification tag and receiving near field radiation from a radio frequency identification tag comprising a layer of conductor having a plurality of non-conductive slits disposed therein, each slit comprising a longitudinal dimension greater than a transverse direction, a feed structure disposed beneath the layer of conductor to couple signal energy between the feed structure and the slits, wherein the feed structure crosses each slit in the transverse direction at least once, and a dielectric layer separating the layer of conductor from the feed structure.
